(19) United States
(12) Patent Application Publication
(10) Pub. No.: US 2024/0380627 A1
(43) Pub. Date: Nov. 14, 2024

(54) METHOD, APPARATUS, ELECTRONIC DEVICE AND STORAGE MEDIUM FOR PROCESSING INFORMATION

(71) Applicant: Beijing Zitiao Network Technology Co., Ltd., Beijing (CN)

(72) Inventors: Zhaoyi Liu, Beijing (CN); Yongqiang Zhao, Beijing (CN)

(21) Appl. No.: 18/661,431

(22) Filed: May 10, 2024

(30) Foreign Application Priority Data
May 11, 2023 (CN) 202310532445.3

(51) Int. Cl. H04L 12/18

(52) U.S. Cl. CPC H04L 12/1818; H04L 12/1822

(57) ABSTRACT

The present disclosure provides a method, an apparatus, an electronic device and a storage medium for processing information. In response to a first predetermined event related to a first object, a first information item related to the first object is fixedly and preferentially displayed in an information flow list of a current user; displaying information related to the first predetermined event in the first information item, wherein the information flow list is used for displaying an information item, and the information item comprises a session item and/or a message item. According to the method of the present disclosure, a first information item is fixedly and preferentially displayed in an information flow list, and thus the experience of reminding a user can be improved.

### CROSS-REFERENCE

The present application claims priority to Chinese Patent Application No. 202310532445.3, filed on May 11, 2023, and entitled “METHOD, APPARATUS, ELECTRONIC DEVICE AND STORAGE MEDIUM FOR PROCESSING INFORMATION”, the entirety of which is incorporated herein by reference.

### FIELD

The present disclosure relates to the field of computer technologies, and in particular, to a method, an apparatus, an electronic device and a storage medium for processing information.

### BACKGROUND

In a communication client, for example, a user may participate in a conference, a schedule, and other events. When the conference starts or the reminder time of the schedule is up, a reminder is sent in the communication client. At present, it is difficult to retrieve the reminder after being viewed, resulting in poor user experience.

### SUMMARY

The present disclosure provides a method, an apparatus, an electronic device and a storage medium for processing information.

The present disclosure adopts the following technical solutions.

In some embodiments, the present disclosure provides a method for processing information, comprising:
in response to a first predetermined event related to a first object, fixedly and preferentially displaying a first information item related to the first object in an information flow list of a current user;
displaying information related to the first predetermined event in the first information item, wherein the information flow list is used for displaying an information item, and the information item comprises a session item and/or a message item.

In some embodiments, the present disclosure provides a method for processing information, comprising:
in response to a first predetermined event related to a first object, highlighting a session item of a first session associated with the first object in an information flow list of a current user;
displaying information related to the first predetermined event in the session item of the first session, wherein the information flow list is used for displaying an information item, the information item comprises a session item and/or a message item, and the first predetermined event does not comprise an event of generating a new message in the first session.

In some embodiments, the present disclosure provides a an apparatus for processing information, comprising:
a control unit configured for, in response to a first predetermined event related to a first object, highlighting a session item of a first session associated with the first object in an information flow list of a current user;
displaying information related to the first predetermined event in the session item of the first session, wherein the information flow list is used for displaying an information item, the information item comprises a session item and/or a message item, and the first predetermined event does not comprise an event of generating a new message in the first session.

In some embodiments, the present disclosure provides an apparatus for processing information, comprising:
a control unit configured for, in response to a first predetermined event related to a first object, fixedly and preferentially displaying a first information item related to the first object in an information flow list of a current user;
displaying information related to the first predetermined event in the first information item, wherein the information flow list is used for displaying an information item, and the information item comprises a session item and/or a message item.

In some embodiments, the present disclosure provides an electronic device, comprising: at least one memory and at least one processor;
wherein the memory is configured for storing program code, and the processor is used for invoking the program code stored in the memory to execute the above-mentioned method.

In some embodiments, the present disclosure provides a computer readable storage medium configured for storing program code, wherein the program code, when run by a processor, cause the processor to execute the above-mentioned method.

According to the method for processing information provided in the embodiments of the present disclosure, in response to a first predetermined event related to a first object, a first information item related to the first object is fixedly and preferentially displayed in an information flow list of a current user; displaying information related to the first predetermined event in the first information item, wherein the information flow list is used for displaying an information item, and the information item comprises a session item and/or a message item. According to the method of the present disclosure, a first information item is fixedly and preferentially displayed in an information flow list, so that the experience of reminding a user can be improved.

### BRIEF DESCRIPTION OF THE DRAWINGS

The above and other features, advantages, and aspects of various embodiments of the present disclosure will become more apparent with reference to the following detailed description taken in conjunction with the accompanying drawings. Throughout the drawings, the same or like reference numerals denote the same or like elements. It should be understood that the drawings are illustrative and that elements and components may not be drawn to scale.

FIG. 1 is a flowchart of a method for processing information according to an embodiment of the present disclosure.

FIG. 2 to FIG. 6 are schematic diagrams of a display interface of a client according to an embodiment of the present disclosure.

FIG. 7 is a flowchart of a method for processing information according to an embodiment of the present disclosure.

FIG. 8 is a structural schematic diagram of an electronic device according to an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that, the steps recorded in the method embodiments of the present disclosure may be executed in parallel. Furthermore, method embodiments may include additional steps and/or omit the illustrated steps. The scope of the present disclosure is not limited in this respect.

The term “comprising” and variations thereof, as used herein, are intended to be inclusive, i.e., “comprising but not limited to”. The term “based on” means “based at least in part on”. The term “one embodiment” means “at least one embodiment”; the term “other embodiment” means “at least one other embodiment”; and the term “some embodiments” means “at least some embodiments”. Relevant definitions of other terms will be given in the following description.

It should be noted that, the “first”, “second”, and other concepts mentioned in the present disclosure are only used to distinguish different apparatuses, modules, or units, but are not used to limit the sequence or dependency of functions performed by these apparatuses, modules, or units.

It should be noted that the modifications of “one” mentioned in the present disclosure are illustrative rather than restrictive, and those skilled in the art should understand that it should be understood as “one or more” unless the context clearly indicates otherwise.

The names of messages or information interacted between a plurality of apparatuses in the embodiments of the present disclosure are only for illustrative purposes, and are not intended to limit the scope of these messages or information.

The solutions provided by the embodiments of the present disclosure will be described in detail below with reference to the accompanying drawings.

For example, in a terminal having a communication client, a user may set events such as a schedule or a conference. When reminder time of the event is up, in the communication client, a reminder is usually displayed in an interface of a calendar or a conference, and disappears after being viewed. In such a reminding manner, on the one hand, the intensity of reminding for a user is too strong, and on the other hand, it is difficult for the user to get back the reminder after viewing it.

As shown in FIG. 1, which is a flowchart of a method for processing information according to an embodiment of the present disclosure. The method comprises the following steps.
S11: in response to a first predetermined event related to a first object, fixedly and preferentially displaying a first information item related to the first object in an information flow list of a current user.

In some embodiments, the method provided by the present disclosure may be applied to a terminal, and more particularly, may be applied to a client on the terminal. The client may be, for example, an instant communication client, or may be a collaborative office platform having an instant communication function. In some embodiments, the first object may be, for example, a schedule, a conference, a plan, a task, a document, etc., and the first predetermined event may be a reminder time being up and triggering a reminding condition, for example, a conference being about to start, a schedule being modified, etc. After the first predetermined event of the first object is generated, the first object is fixedly and preferentially displayed in the information flow list of the current user. In some embodiments, the first information item is fixedly and preferentially displayed in the information flow list, which indicates that the position of the first information item in the information flow list is fixed, and it does not change when other information items generate a message, for example, the position may not change when a new session message is generated in a session item, and which also indicates that the display position of the first information item is preferential, that is, the display position is preferential over the non-fixed preferential information item, for example, it is displayed at the top of the information flow list. The information items in the information flow list include preferentially displayed information items (e.g., the first information item) and non-preferentially displayed information items. The display positions of the preferentially displayed information items may be further upward than those of the non-preferentially displayed information items. In some embodiments, if there are multiple preferentially displayed information items, the positions of the multiple preferentially displayed information items are all further upward than those of other non-preferentially displayed information items. In some embodiments, if there are a plurality of information items that are fixedly and preferentially displayed, they may be sorted according to the time when they are set to be displayed fixedly and preferentially. That is, the information item that is firstly set to be displayed fixedly and preferentially may be arranged at the foremost position, and the other information items that are fixedly and preferentially displayed may be sorted sequentially according to time order. Taking fixed and preferential display as top display for example, the item set earliest to be displayed fixedly and preferentially may be fixed at the top of the information flow list, and if another fixedly and preferentially displayed information item is generated, it is arranged next to the previous fixedly and preferentially displayed information item, and so on.
S12: displaying information related to the first predetermined event in the first information item, wherein the information flow list is used for displaying an information item, and the information item comprises a session item and/or a message item.

In some embodiments, the information flow list is used for displaying an information item, which comprises a session item and/or a message item. The session item may include a single-person session and a group session, and may include a robot session and non-robot session, or a group session with a robot and a non-robot. The message item may include a notification message item. The difference between the message item and the session item may be that the message item does not correspond to a session. When the message item is clicked, a target page indicated by the notification message may be opened. However, a session item is an entrance of a corresponding session. When the session item is clicked by a user, a session interface of the corresponding session may be opened, through which the user may send/receive a message to/from other session members. The first information item may be a message item or a session item, and the information flow list may be, for example, a session list in the client. In some embodiments, the first object is not a session, and may be an object associated with a certain session, for example, an event associated with a certain session, such as a conference and a schedule. The information related to the first predetermined event may include, for example, content of the first predetermined event, thumbnail information, information of the first object, an operation control, and the like.

In some embodiments of the present disclosure, information related to a first predetermined event of a first object is displayed in a first information item. Thus, the information related to the first predetermined event of the first object becomes a real information item in an information flow. In this way, the information related to the first object is displayed in the information flow in the form of an information item. The information (for example, a schedule reminder, a conference reminder, and a conference start) related to the first predetermined event may be connected into the information flow, thus a user may quickly find it in the information flow list (for example, a session list), which improving the access efficiency. The user may not need to repeatedly jump between the information flow list and other pages such as the schedule reminder interface.

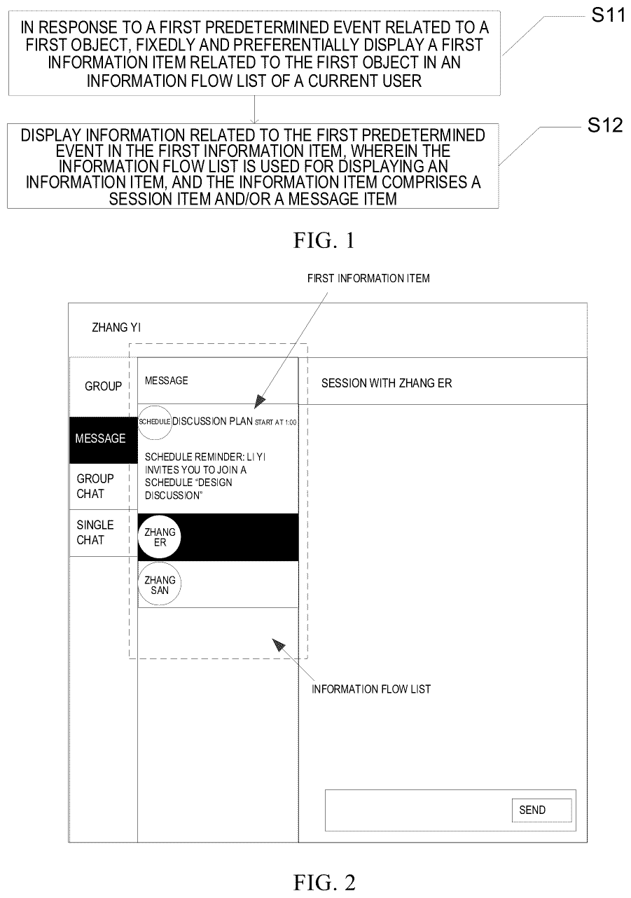

In some embodiments, the information related to the first predetermined event may be displayed in the first information item, and may be viewed without triggering the first information item by means of clicking or the like. Furthermore, after the first information item is triggered by means of clicking or the like, a target page (when the first information item is a message item) or a session interface (when the first information item is a session item) corresponding to the first information item may be invoked. For example, as shown in FIG. 2, the information flow list comprises, from top to bottom, a first information item, a session item of a session between the current user and Zhang Er, and a session item of a session between the current user and Zhang San. With continued reference to FIG. 2, information of a schedule reminder of a schedule (a first object) is displayed in the first information item in the information flow list (the first predetermined event is the reminder time being up, for example, reminding 5 minutes in advance, and information of a schedule reminder is information related to a first predetermined event). In this case, the first information item needs not to be opened by clicking. It may also click the first information item to invoke the details interface of the first information item, wherein the details interface may be a session interface. The detailed information related to the first predetermined event may be displayed in the session interface in manners such as a top card and a message.

In some embodiments of the present disclosure, after a first predetermined event related to the first object is generated, the first information item is fixedly and preferentially displayed in the information flow list, so that a user can view information related to the first predetermined event in the information flow. For a user who uses the information flow as a main working entry, he/she may be informed of the first predetermined event effectively. Furthermore, because the first information item is fixedly and preferentially displayed in the information flow list, it will not be pushed away by other information items after the user views information related to the first information item (for example, the first information item is triggered by clicking or the like, and a session interface of the first information item is invoked so that the information related to the first predetermined event is viewed on the session interface). For example, the position of the first information item in the information flow list will not change when a session message is generated by other sessions. During the fixed and preferential displaying of the first information item, its position in the information flow list is always the preferential position. Therefore, the user can easily and conveniently find the first information item. Further, the reminding manner, in which the user is reminded of the first predetermined event in the information flow list, is less disturbing to the user than the popup window reminding manner. In addition, the user needs not to repeatedly switch between the information flow list and other interfaces. Therefore, the overall experience of the user is better.

In some embodiments of the present disclosure, the first object is associated with a first session; the first information item is a session item corresponding to the first session. An identification of the first session and information related to the first predetermined event are displayed in the first information item. In some embodiments, the first session may be any session, it may be a group session, or a single-chat session, or it may be a robot session, or a session comprising a non-robot user. The first session has an associated first object, which includes, for example, an associated item such as a schedule, a conference, or a plan associated with the first session. The first object is associated with the first session. For example, the first object may be an object created in the first session, for example, an object created in the first session by a member of the first session, such as a conference, a schedule, and a task. In the first information item, the identification of the first session and information related to the first predetermined event are displayed. For example, the name and avatar of the first session and notification information related to the first predetermined event are displayed. In some embodiments, when the first object of the first session needs to perform a non-session message notification (rather than when a session message is received in the first session), a first information item is fixedly and preferentially displayed automatically, which facilitates a user to view the notification and can quickly find the first session.

In some embodiments of the present disclosure, the first predetermined event does not comprise that a new message is generated in the first session. That is, in some embodiments, the fixed and preferential display is not triggered by a new message generated in the first session. In other words, a session item of the first session is displayed fixedly and preferentially because of the first predetermined event related to a first object related to the first session, rather than the new message generated in the first session. The new message here may be a session message sent by a user or a system in the first session. In a case that the first object is conference, and the first predetermined event is the reminder time of the conference being up, the conference is associated with the first session, and the first session may be a conference group associated with the conference. The session items of the first session will not be displayed fixedly and preferentially because of the session messages sent by the user in the first session. Instead, the session item of the first session is displayed fixedly and preferentially because the conference reminder time is up. In other embodiments, after a session item of the first session is displayed fixedly and preferentially, a corresponding message may be sent in the first session, wherein the corresponding message may be generated based on the first predetermined event. For example, information related to the first predetermined event may be sent by a robot in the first session.

In some embodiments of the present disclosure, the method further comprises: in response to an operation of triggering the first information item in the information flow list, opening a session interface of the first session, wherein information of the first predetermined event is displayed at the top of the session interface of the first session.

In some embodiments, after the first information item in the information flow list is triggered by clicking or the like, a session interface of the first session may be displayed. The information related to the first predetermined event may be displayed at the top of the session interface. The limitation of a display area of a first information item in the information flow list may result in incomplete display of information related to the first predetermined event. Therefore, the information related to the first predetermined event may be displayed on the session interface of the first session, so that the user can know the situation conveniently. Furthermore, it is convenient for the user to notice the information in a manner of being placed at the top (for example, being displayed at the top notification bar of the session interface).

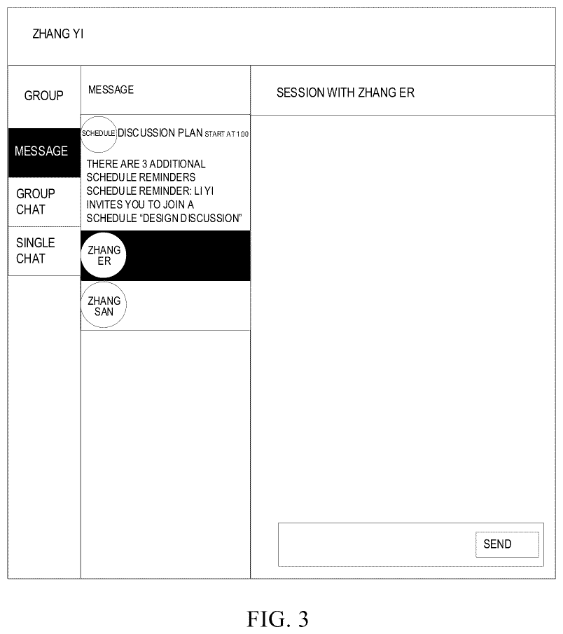

In some embodiments of the present disclosure, the first session is a session with a robot assistant, the member of which includes a current user and a robot assistant. Taking FIG. 2 as an example, a user may set a schedule in a calendar, in which case the first object is the schedule (a schedule title is “discussion plan”), and the first predetermined event is a reminder time of the schedule being up. Therefore, with a session item of a session between the robot assistant responsible for the schedule and the current user, information related to the first predetermined event “schedule reminder: Li Yi invites you to join the schedule ‘Design discussion’” is displayed. If there are a plurality of first objects, for example, a plurality of schedules need to be reminded, information related to first predetermined events of other schedules may be displayed aggregately, as shown in FIG. 3, “there are additional three schedule reminders”.

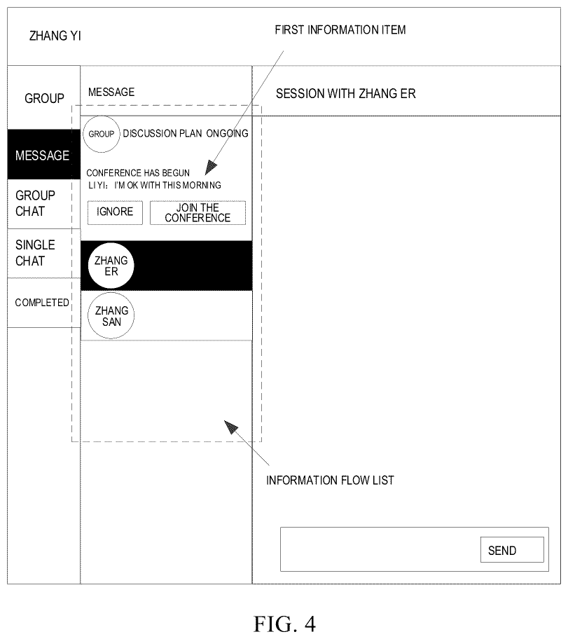

In some embodiments of the present disclosure, the first information item is a session item of a first session. The first session is a group session comprising a non-robot user. Taking FIG. 4 as an example, the first information item (i.e., the session item of the first session) is fixedly displayed at the top of the message group. Here, the first session is a group session with a group name of “study plan” displayed in the first information item in FIG. 4, and the first object is a conference associated with the group “study plan”. The session item of the first session is fixedly displayed at the top of an information flow list corresponding to the message group. In the first information item in FIG. 4, the name of the group session “discussion plan” is displayed, and the state information “conference has begun” related to the first predetermined event and related controls “ignore” and “join the conference” are displayed. In this way, the user may instantly know the related state of the first object associated with the first session, and may conveniently execute some operations, for example, ignoring the conference or joining the conference. In some embodiments, when the first information item is a group session comprising a non-robot user (e.g., FIG. 4), the session item may be triggered by clicking, etc. to enter the first session.

In some embodiments of the present disclosure, in accordance with a determination that the session associated with the first object only comprises the session with the robot assistant, the first session is the session with the robot assistant; or, in accordance with a determination that the session associated with the first object comprises the group session, the first session is the group session.

In some embodiments, taking the first object being a schedule as an example, the schedule may be associated with a session with a robot assistant for processing the schedule by default. If the schedule is not associated with any group session comprising a non-robot user, the session with a robot assistant is considered by default as the first session. If the schedule is associated with another group session, the group session is considered as the first session. Because a group session with a human user is a session that is more concerned by the current user than a session without a human user, such as a session with a robot assistant. Therefore, in some embodiments, if the first object is associated with another group session, the group session is used as the first session to display information related to the first predetermined event, and if the first object is not associated with another group session, the session with a robot assistant is used as the first session.

In some embodiments of the present disclosure, after canceling the fixed and preferential display of the first information item related to the first object in the information flow list of the current user, determining a position of the first information item in the information flow list based on an update time of the first information item and displaying the first information item; the update time comprises: a time when the fixed and preferential display of the first information item is cancelled and/or a time when a new message is generated in the first session associated with the first object.

In some embodiments, the fixed and preferential display of the first information item may be cancelled. After that, the first information item becomes an ordinary information item, the display position thereof in the information flow list will no longer be fixed. The sorting position of the first information item in the information flow list is determined based on an update time and the first information item is displayed. In the information flow list, an information item with a small interval between the update time and the current time may be displayed preferentially before an information item with a large interval between the update time and the current time. The update time of the first information item may be the time when the fixed and preferential display of the first information item is cancelled.

In some embodiments of the present disclosure, the number of the first objects is at least two. In the first information item displayed fixedly and preferentially in the information flow, information related to a first predetermined event related to a target object is preferentially displayed, and information related to the first predetermined event related to other first objects is aggregately displayed. The target object is a first object with the earliest start time. Or, information related to the first predetermined event related to all the first objects is aggregately displayed in the first information item.

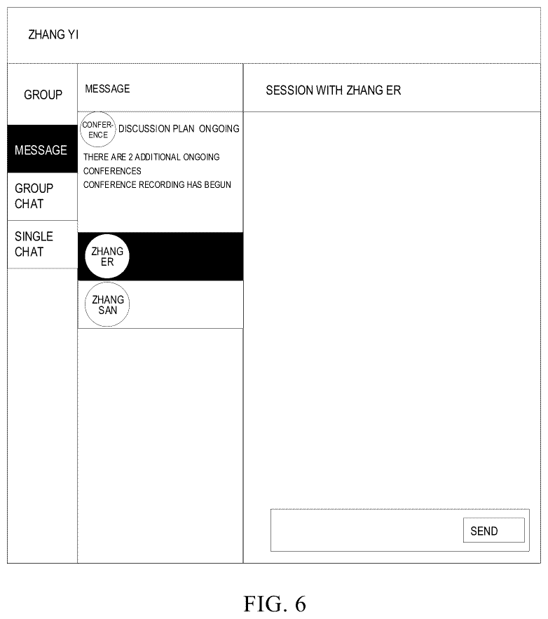

In some embodiments, as shown in FIGS. 3 and 6, the number of first objects is at least two. Therefore there are also at least two first predetermined events related to the first objects. In the first information item, only information related to a first predetermined event of one first object may be displayed in an expanded manner, and information related to a first predetermined event of other first objects is displayed in an aggregated manner, for example, “there are additional three schedule reminders” in FIG. 3, and ‘“there are additional two ongoing conferences” in FIG. 6. With regard to the aggregately displayed information, it may be triggered by means of clicking so as to view details.

In some embodiments of the present disclosure, in the first information item, information related to the first predetermined event related to the target object is preferentially displayed, and information related to the first predetermined event related to other first objects is aggregately displayed; the method further comprises: after the target object is completed, determining a next target object with the earliest start time from other uncompleted first objects, and displaying information related to a first predetermined event related to the next target object with the earliest start time.

In some embodiments, when there are a plurality of first objects, a first object starting earliest is determined, and information related to a first predetermined event of the first object is displayed in an expanded manner. After the first object is completed, a next first object with the earliest start time is selected from other first objects, and the information related to the first predetermined event is displayed.

In some embodiments of the present disclosure, if at least one of the first objects is not completed, the fixed and preferential display of the first information item in the information flow list of the current user is not automatically cancelled; if all the first objects are completed, the fixed and preferential display of the first information item in the information flow list of the current user is automatically cancelled; wherein the first object completes if the first object is ignored, rejected, or ended. In some embodiments, when all the first objects are not completed, the first information items are displayed fixedly and preferentially, and if all the first objects are completed, the fixed and preferential display of the first information items is cancelled.

In some embodiments of the present disclosure, the method further comprises: in response to a predetermined operation of the first information item displayed fixedly and preferentially in the information flow list, switching information preferentially displayed in the first information item from information related to the first predetermined event related to the target object to information related to a first predetermined event related to another first object.

In some embodiments, when there are at least two first objects, due to the limitation of the display area of the first information item, partial information related to a first predetermined event related to the first objects is aggregately displayed. A user may want to view information related to the first predetermined event related to other first objects displayed aggregately. Therefore, a predetermined operation is set, which may be, for example, an operation of sliding to the left or to the right on the first information item. In this way, information related to a predetermined event displayed on the first information item may be switched. For example, the reminder information of one schedule is preferentially displayed, while the reminder information of other schedules is aggregately displayed. In such a case, the reminder information of another schedule is switched to and preferentially displayed by sliding to the left or right on the first information item.

In some embodiments of the present disclosure, the method further comprises: in response to a trigger operation for the first information item, displaying a detail interface corresponding to the first information item, wherein the information related to a first predetermined event related to each of the first objects is displayed in the detail interface.

In some embodiments, the trigger operation may be a click operation. After the first information item is triggered, a detail interface of the first information item may be displayed, which may be a session interface of a first session corresponding to the first information item. The information related to the first predetermined event related to each first object may be displayed on the detail interface, so that the user may know about related situation. Further, the information related to the first predetermined event is displayed at the top of the detail interface (for example, displayed in the top notification bar of the session interface), so that the user may notice the information.

In some embodiments of the present disclosure, fixedly and preferentially displaying a first information item related to the first object in an information flow list of a current user comprises: fixedly displaying the first information item at the top of the information flow list of the current user. In some embodiments, the first information item is fixedly at the top of the information flow list, and its position is not changed. If there are other information items being fixedly at the top, the information items being fixedly at the top may all be arranged in front of the information items being not fixedly at the top, and the positions are fixed. The positions of the plurality of information items being fixedly at the top may be determined according to the time when they are fixed at the top.

In some embodiments of the present disclosure, fixedly and preferentially displaying a first information item related to the first object in an information flow list of a current user comprises: determining a target group to which the first session belongs, the target group comprising at least one group; fixedly and preferentially displaying the first information item in respective information flow list corresponding to each target group, or fixedly and preferentially displaying the first information item in an information flow list corresponding to a designated target group in the target group.

In some embodiments, as shown in FIG. 4, which shows a schematic diagram of a display interface of a client. It can be seen from the figure, a client has a plurality of groups, comprising “message”, “group chat”, “single chat”, and a “completed” and so on. The first session may belong to the plurality of groups. For example, if the first session is a group session, the first session may belong to both a message group and a group chat group. One group corresponds to one information flow list (for example, a session list). If the first session belongs to a plurality of target groups at the same time, the first information items may be fixedly and preferentially displayed in the information flows respectively corresponding to the plurality of target packets. In this way, when the user switches to a different group, the first information item always can be viewed such that the reminder of the first information item is relevant to the first session. The user may also formulate a target group, so that the first information item is fixedly and preferentially displayed only in the information flow list corresponding to the target group. For example, when the message group is taken as the target group, the first information item is fixedly and preferentially displayed only in the information flow corresponding to the message group.

In some embodiments of the present disclosure, the first object comprises a schedule; the first predetermined event comprises: a predetermined reminder time of the schedule being up. In some embodiments, the schedule may include, for example, events written in the calendar that needs to be processed, etc. The appointment reminder of the schedule may be, for example, an upcoming reminder made before the beginning. In some embodiments, the reminder time is usually before the start time of the schedule, for example, 5 to 10 minutes before the start time, and the reminder time may be no earlier than the schedule 24 h.

In some embodiments of the present disclosure, the current user is a participant of the schedule, or the current user is a user among the participants of the schedule who does not reject the schedule, or the current user is a user among the participants of the schedule who accepts the schedule. Since the current user is a participant of a schedule and a user who receives or does not reject the schedule, information related to the first predetermined event is displayed in the information flow list of the current user. If the current user is not the above-mentioned user, it indicates that the current user is not interested in the schedule, thus information related to the first predetermined event needs not to be displayed in the information flow list of the current user.

In some embodiments of the present disclosure, state information of the schedule is displayed in the first information item, and the state information of the schedule is updated as a state of the schedule is updated.

In some embodiments, as shown in FIG. 2, the first information item in FIG. 2 is a session item of a session with a robot assistant responsible for a schedule. A title “discussion plan” of the schedule and a notification message “schedule reminder: Li Yi invites you to join schedule of design discussion” may be displayed in the first information item, and state information “start at 1:00” of the schedule is displayed in the first information item. The state information may be changed as the state of the schedule changes, for example, if the start time changes, the state information will also change.

In some embodiments of the present disclosure, the method further comprises: in response to the current user's rejection of the schedule or a start time of the schedule being up, cancelling the fixed and preferential display of the first information item of the schedule. In some embodiments, when the current user rejects the schedule or the schedule has begun, the current user needs not to be reminded, therefore fixed and preferential display of the first information item is cancelled.

In some embodiments, the number of the schedules satisfying the reminding condition may be at least two. In this case, the schedule notification of the schedule with the earliest start time is displayed in the first information item, and the number of the schedule notifications of the remaining schedules is displayed. For example, “there are additional three schedule reminders” as shown in FIG. 3.

In some embodiments of the present disclosure, the first object comprises a conference; the first predetermined event comprises one or more of the following: a start of the conference, a reminder before the start of the conference. In some embodiments, the first object may be a conference, and the conference has information that needs to be notified, for example, a reminder indicating a conference is about to start before the start of the conference. As shown in FIG. 4, the first information item is a session item of the first session. In the session item, a name of the first session “discussion plan” is displayed, and a message “Li Yi: I'm OK with this morning” sent by a participant of the conference may also be displayed.

In some embodiments, the current user is a participant of the conference, or the current user is a user who does not reject a schedule of the conference. In this case, the current user needs to be reminded. If the current user does not participate in the conference or has rejected the schedule of the conference, the information related to the first predetermined event need not to be fixedly displayed at the top.

In some embodiments, after fixedly and preferentially displaying the first information item related to the first object in the information flow list of the current user, in accordance with a determination that a conference group of the conference is created, fixedly and preferentially displaying a session item corresponding to the conference group in the information flow list, displaying information related to the first predetermined event in the session item corresponding to the conference group, and cancelling the fixed and preferential display of the first information item. In some embodiments, the conference group is a group created for a conference, and members thereof may be participants of the conference. Compared with the first session, a conference group, as a group created specifically for a conference, has a higher closeness to the conference. Therefore, if a conference group of a conference is created, a session item corresponding to the conference group is fixedly and preferentially displayed. In addition, the fixed and preferential display of the first information item is cancelled, the position of the first information item in the information flow list is determined based on an update time of the first information item and the first information item is displayed. Then, the information related to the first predetermined event and the state information of the conference and the like may be displayed in the session item corresponding to the conference group.

In some embodiments, the method further comprises: in response to an operation of ignoring the conference, cancelling the fixed and preferential display of a first information item related to the conference, or in response to an end of the conference, cancelling the fixed and preferential display of the first information item related to the conference. In some embodiments, as shown in FIG. 4, a control for ignoring a conference is displayed in a first information item. If a notification message of the conference is ignored, it indicates that a user is not interested in the conference. If the conference has ended, it indicates that the conference does not need to be followed, and therefore the fixed and preferential display of the notification message of the conference is cancelled.

In some embodiments, the method further includes: in response to a completion operation performed on the first information item, adding the first information item to a completed group. In some embodiments, a completed group is provided (as shown in FIG. 4). The first information item may be added to the completed group by, for example, marking it as completed.

In some embodiments, a conference invitation interface is displayed before a conference starts. When the conference invitation interface is displayed, a first information item has not been fixedly and preferentially displayed in the information flow list. After the conference invitation interface of the conference disappears, the first information item is fixedly and preferentially displayed in the information flow list. In some embodiments, the first object is a conference; the first predetermined event may be the start time of the conference being up; before starting the conference, a conference invitation is sent to participants of the conference; a conference invitation interface may be a pop-up window; the pop-up window displays an invitation to join the conference and may provide a control for accepting or refusing to enter the conference; and a user can enter the conference via the control in the pop-up window. If the current user initiatively enters the conference (for example, enters via a control in the conference invitation interface), starts the conference, and the conference invitation is not accepted, the invitation interface of the conference disappears, and at this time, the first information item of the conference is fixedly and preferentially displayed, and when the conference invitation interface does not disappear, the invitation may be known about via the conference invitation interface, and therefore the first information item of the conference needs not to be displayed.

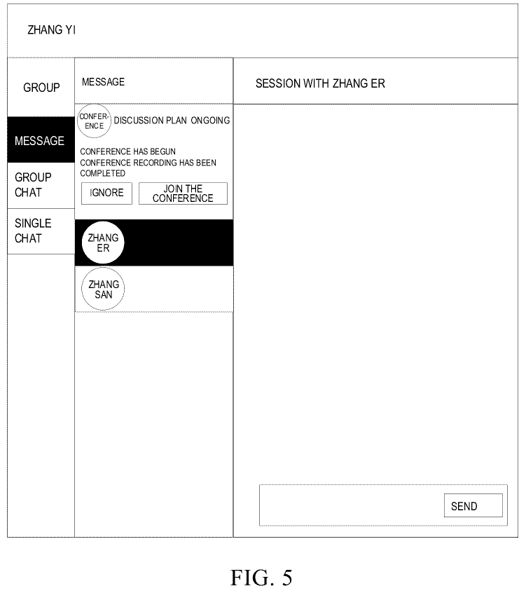

In some embodiments of the present disclosure, the first information item has a first control for joining the conference. In some embodiments, as shown in FIG. 5, a control “join conference” is displayed in the first information item. After the control is triggered by clicking or the like, a user may directly join the conference, thereby convenience is improved.

In some embodiments, the first information item has a first control for joining the conference, and different types of the conference correspond to different styles of the first control. In some embodiments, the style of the first control comprises a color, a displayed text, etc. of the first control, and the type of the conference may be a video conference, a network symposium, a lottery conference, etc. When the type of the conference is changed, the text and the color displayed in the first control may be automatically changed, so that a user can know about the type of the conference through the style of the first control.

In some embodiments, the first information item has a second control for ignoring the conference. As shown in FIG. 5, a first information item has a “ignore” control. The conference is ignored by triggering the control. If all first objects are ignored, the fixed and preferential display of the first information item may be canceled.

In some embodiments, state information of the conference is displayed in the first information item, and the state information of the conference is updated as a state of the conference is updated. As shown in FIG. 5, in the first information item, the state information of the conference, such as “conference has begun” and “conference recording has been completed”, may be displayed, and the user may directly know the current state of the conference through the first information item.

Some embodiments of the present disclosure further provide a method for processing information. The method may have the technical features in other embodiments of the present disclosure without any conflict. The technical features in other embodiments of the present disclosure may be used in the present embodiment in the case of no conflict. As shown in FIG. 7, the method for processing information in this embodiment comprises:
S21: in response to a first predetermined event related to a first object, highlighting a session item of a first session associated with the first object in an information flow list of a current user.

In some embodiments, the explanations of the first object, the first predetermined event, the information flow list and the first session in other embodiments may also be used in this embodiment without conflict. The highlighting may be fixed and preferential display, and may also be display ways different from other information items, such as highlight display, blinking display, shaking display, and so on.
S22: displaying information related to the first predetermined event in the session item of the first session, wherein the information flow list is used for displaying an information item, the information item comprises a session item and/or a message item, and the first predetermined event does not comprise an event of generating a new message in the first session.

In some embodiments, the explanations of the information item, the session item, and the message item in other embodiments may also be used in this embodiment without conflicts. In some embodiments, the first object is associated with the first session. The highlight is triggered not by a new message generated in the first session. The session item of the first session is highlighted because of the first predetermined event related to the first object related to the first session. The new message herein may be a session message sent by a user or a system in the first session. In some embodiments, the first session item is highlighted, so that the user can know the information related to the first predetermined event in time, and the user can conveniently enter the first session related to the first predetermined event, thereby facilitating operations and improving the processing efficiency of the user.

In some embodiments of the present disclosure, the first object comprises a schedule, and the first predetermined event comprises a predetermined reminder time of the schedule being up; the first session comprises an associated group session of the schedule or a session with a schedule robot assistant.

In some embodiments, the schedule may be a schedule input in advance through a calendar interface, and the schedule has an appointment reminder time, which is usually a reminder time written when the schedule is established. A group session associated with a schedule is, for example, a group session composed of users related to the schedule, and may be a group session responsible for processing and discussing the schedule. Any schedule may be associated with the schedule robot assistant by default. If the schedule has an associated group session, the first session is an associated group session of the schedule; and if the schedule has no associated group session, the first session is a session with a schedule robot assistant, because compared with the session with a schedule robot assistant, the group session is more relevant to the schedule.

In some embodiments, the first object comprises a conference; the first predetermined event comprises one or more of the following: a start of the conference, a reminder before the start of the conference; the first session comprises an associated group session of the conference or a session with a conference robot assistant.

In some embodiments, the explanation of the conference in other embodiments is also applicable to this embodiment without conflicts. At or before the start of a conference, information related to a first predetermined event is displayed, so that a user can instantly know about dynamic situation of the conference through the first session item. Any conference may be associated with the schedule robot assistant by default. If the session has an associated group session, the first session is an associated group session of the conference; and if the conference has no associated group session, the first session is a session with a schedule robot assistant.

In some embodiments, the method further comprises: in response to an operation of triggering a session item of the first session in the information flow list, opening a session interface of the first session, wherein information of the first predetermined event is displayed at the top of the session interface of the first session.

In some embodiments, the limitation of a display area of a first session item in the information flow list may result in incomplete display of information related to the first predetermined event. Therefore, the session item of the first session may be triggered by clicking and the like, so that the information related to the first predetermined event may be displayed on the session interface of the first session, therefore the user can know the situation conveniently. Furthermore, it is convenient for the user to notice the information in a manner of being placed at the top (for example, being displayed at the top notification bar of the session interface).

Some embodiments of the present disclosure further provide an apparatus for processing information, comprising:
a control unit configured for, in response to a first predetermined event related to a first object, fixedly and preferentially displaying a first information item related to the first object in an information flow list of a current user;
displaying information related to the first predetermined event in the first information item, wherein the information flow list is used for displaying an information item, and the information item comprises a session item and/or a message item.

In some embodiments, the first object is associated with a first session;
the first information item is a session item corresponding to the first session.

In some embodiments, the first predetermined event does not comprise that a new message is generated in the first session.

In some embodiments, the control unit is further configured for: in response to an operation of triggering the first information item in the information flow list, opening a session interface of the first session, wherein information of the first predetermined event is displayed at the top of the session interface of the first session.

In some embodiments, the first session is: a session with a robot assistant; or a group session comprising a non-robot user.

In some embodiments, in accordance with a determination that the session associated with the first object only comprises the session with the robot assistant, the first session is the session with the robot assistant; or, in accordance with a determination that the session associated with the first object comprises the group session, the first session is the group session.

In some embodiments, the control unit is further configured for: after canceling the fixed and preferential display of the first information item related to the first object in the information flow list of the current user, determining a sorting position of the first information item in the information flow list based on an update time of the first information item and displaying the first information item; the update time comprises: a time when the fixed and preferential display of the first information item is cancelled and/or a time when a new message is generated in the first session associated with the first object.

In some embodiments, in response to the number of the first objects is at least two, preferentially displaying, in the first information item, information related to a first predetermined event related to a target object, and aggregately displaying information related to the first predetermined event related to other first objects, wherein the target object is a first object with the earliest start time.

In some embodiments, preferentially displaying, in the first information item, information related to the first predetermined event related to the target object, and aggregately displaying information related to the first predetermined event related to other first objects; the control unit is further configured for: after the target object is completed, determining a next target object with the earliest start time from other uncompleted first objects, and displaying, in the first information item, information related to a first predetermined event related to the next target object with the earliest start time;

In some embodiments, the control unit is further configured for: in response to a predetermined operation of the first information item, switching information preferentially displayed in the first information item from information related to the first predetermined event related to the target object to information related to a first predetermined event related to another first object;

In some embodiments, the control unit is further configured for: in response to a trigger operation for the first information item, displaying a detail interface corresponding to the first information item, wherein the information related to a first predetermined event related to each of the first objects is displayed in the detail interface;

In some embodiments, in accordance with a determination that at least one of the first objects is not completed, refraining from automatically cancelling the fixed and preferential display of the first information item in the information flow list of the current user, and in accordance with a determination that all the first objects are completed, automatically cancelling the fixed and preferential display of the first information item in the information flow list of the current user; wherein, in accordance with a determination that the first object is ignored, rejected, or ended, the first object is completed.

In some embodiments, fixedly and preferentially displaying a first information item related to the first object in an information flow list of a current user comprises: fixedly displaying the first information item at the top of the information flow list of the current user.

In some embodiments, fixedly and preferentially displaying a first information item related to the first object in an information flow list of a current user comprises:
determining a target group to which the first session belongs, the target group comprising at least one group;
fixedly and preferentially displaying the first information item in respective information flow list corresponding to each target group, or fixedly and preferentially displaying the first information item in an information flow list corresponding to a designated target group in the target group.

In some embodiments, the control unit is further configured for: in response to a second predetermined event related to the first object, cancelling the fixed and preferential display of the first information item related to the first object in the information flow list of the current user.

In some embodiments, the first object comprises a schedule;
the first predetermined event comprises: a predetermined reminder time of the schedule being up.

In some embodiments, the current user is a participant of the schedule, or the current user is a user among the participants of the schedule who does not reject the schedule, or the current user is a user among the participants of the schedule who accepts the schedule.

In some embodiments, state information of the schedule is displayed in the first information item, and the state information of the schedule is updated as a state of the schedule is updated.

In some embodiments, the control unit is further configured for: in response to the current user's rejection of the schedule or a start time of the schedule being up, cancelling the fixed and preferential display of the first information item of the schedule.

In some embodiments, the first object comprises a conference;
the first predetermined event comprises one or more of the following: a start of the conference, a reminder before the start of the conference.

In some embodiments, the current user is a participant of the conference, or the current user is a user who does not reject a schedule of the conference.

In some embodiments, after fixedly and preferentially displaying the first information item related to the first object in the information flow list of the current user, in accordance with a determination that a conference group of the conference is created, fixedly and preferentially displaying a session item corresponding to the conference group in the information flow list, displaying information related to the first predetermined event in the session item corresponding to the conference group, and cancelling the fixed and preferential display of the first information item.

In some embodiments, the control unit is further configured for: in response to an operation of ignoring the conference, cancelling the fixed and preferential display of a first information item related to the conference, or in response to an end of the conference, cancelling the fixed and preferential display of the first information item related to the conference;

In some embodiments, the control unit is further configured for: in response to a completion operation performed on the first information item, adding the first information item to a completed group.

In some embodiments, the first information item has a first control for joining the conference;

In some embodiments, the first information item has a first control for joining the conference and different types of the conference corresponding to different styles of the first control;

In some embodiments, the first information item has a second control for ignoring the conference;

In some embodiments, state information of the conference is displayed in the first information item, and the state information of the conference is updated as a state of the conference is updated.

The present disclosure further provides an apparatus for processing information, comprising: a control unit configured for, in response to a first predetermined event related to a first object, highlighting a session item of a first session associated with the first object in an information flow list of a current user;
displaying information related to the first predetermined event in the session item of the first session, wherein the information flow list is used for displaying an information item, the information item comprises a session item and/or a message item, and the first predetermined event does not comprise an event of generating a new message in the first session.

In some embodiments, the first object comprises a schedule, and the first predetermined event comprises a predetermined reminder time of the schedule being up; the first session comprises an associated group session of the schedule or a session with a schedule robot assistant;

In some embodiments, the first object comprises a conference; the first predetermined event comprises one or more of the following: a start of the conference, a reminder before the start of the conference; the first session comprises an associated group session of the conference or a session with a conference robot assistant.

In some embodiments, the control unit is further configured for: in response to an operation of triggering a session item of the first session in the information flow list, opening a session interface of the first session, wherein information of the first predetermined event is displayed at the top of the session interface of the first session.

For the embodiment of the apparatus, the apparatus embodiments substantially corresponds to the method embodiment, thus the relevant parts thereof may be described with reference to the method embodiment. The apparatus embodiments described above are merely exemplary, and modules described as separate modules may or may not be separated. A part or all of the modules may be selected according to actual needs to achieve the objectives of the solutions of the embodiments. A person of ordinary skill in the art may understand and implement the present application without creative efforts.

In a word, the method and apparatus of this disclosure are described based on the embodiments and use cases. Moreover, the present disclosure further provides an electronic device and a computer readable storage medium, which are described below.

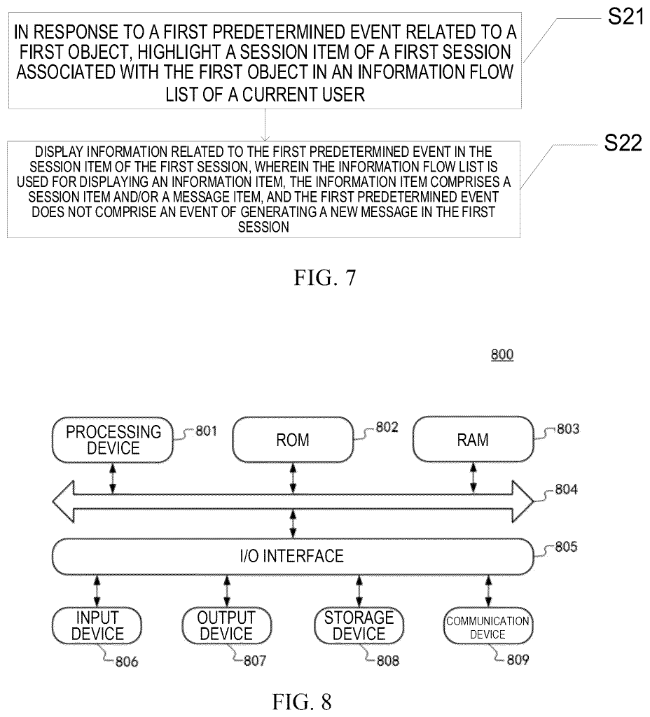

Referring now to FIG. 8, which shows a schematic structural diagram of an electronic device (for example, terminal device or server) 800 suitable for implementing embodiments of the present disclosure. The terminal device in the embodiment of the present disclosure may comprise, but is not limited to, a mobile terminal such as a mobile phone, a notebook computer, a digital broadcast receiver, a PDA (Personal Digital Assistant), a PAD (tablet computer), a PMP (Portable Multimedia Player), an onboard terminal (such as an onboard navigation terminal) and the like, and a fixed terminal such as a digital TV, a desktop computer, and the like. The electronic device shown in figures is merely an example and should not limit the functions and scope of use of embodiments of the present disclosure in any way.

The electronic device 800 may comprise a processing device (e.g., central processing unit, graphics processor, etc.) 801 that may perform various suitable actions and processes in accordance with a program stored in read only memory (ROM) 802 or a program loaded into random access memory (RAM) 803 from storage device 808. The RAM 803 also stores various programs and data necessary for the operation of the electronic device 800. The processing device 801, the ROM 802, and the RAM 803 are connected to each other via the bus 804. An input/output (I/O) interface 805 is also connected to bus 804.

In general, the following apparatus may be connected to the I/O interface 805: input device 806 comprising, for example, touch screen, touch pad, keyboard, mouse, camera, microphone, accelerometer, gyroscope, etc.; an output device 807 comprising, for example, a liquid crystal displays (LCD), speaker, vibrator, or the like; a storage device 808 comprising, for example, a magnetic tape, a hard disk, or the like; and a communication device 809. The communication device 809 may allow the electronic device 800 to wirelessly or wired communicate with other devices to exchange data. While FIG. 8 illustrates an electronic device 800 with a variety of apparatuses, it is to be understood that not all of the illustrated apparatuses are required to be implemented or provided. More or fewer apparatuses may alternatively be implemented or provided.

In particular, the processes described above with reference to the flowcharts may be implemented as computer software programs in accordance with embodiments of the present disclosure. For example, embodiments of the present disclosure comprise a computer program product comprising a computer program carried on a computer readable medium. The computer program comprises a program code for executing the method as shown in the flowchart. In such an embodiment, the computer program may be downloaded and installed from the network via communications apparatus 809, installed from storage device 808, or installed from ROM 802. When the computer program is executed by the processing device 801, the described functions defined in the method of embodiments of the present disclosure are executed.

It should be noted that the computer readable medium in the present disclosure may be a computer readable signal medium or a computer readable storage medium, or any combination thereof. A computer readable storage medium may be, for example, but not limited to, an electronic, magnetic, optical, electromagnetic, infrared, or semiconductor system, apparatus, or device, or any combination thereof. More specific examples of the computer readable storage medium may comprise, but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contain or store a program for use by or in connection with an instruction execution system, apparatus, or device. While in the present disclosure, a computer readable signal medium may comprise a data signal carrying computer readable program code in baseband or propagated as a part of carrier wave. Such a propagated signal may take any of a variety of forms, comprising, but not limited to, electro-magnetic, optical signal, or any suitable combination thereof. A computer readable signal medium may also be any computer readable medium in addition to a computer readable storage medium, and that can send, propagate, or transmit a program for use by or in connection with an instruction execution system, apparatus, or device. Program code embodied on a computer readable medium may be transmitted using any appropriate medium, comprising, but not limited to, wire, optical fiber cable, RF (radio frequency), etc., or any suitable combination thereof.

In some implementations, clients, servers may communicate using any currently known or future developed network protocol such as HTTP (Hypertext Transfer Protocol) and may be interconnected with digital data communication (e.g., a communication network) in any form or medium. Examples of communication networks comprise a local area network (“LAN”), a wide area network (“WAN”), an internetwork (e.g., the Internet), and a peer-to-peer network (e.g., an ad hoc peer-to-peer network), as well as any currently known or future developed network.

The computer readable medium may be comprised in the electronic device, or may exist separately and not be installed in the electronic device.

The above computer readable medium carries one or more programs, which when executed by the electronic device, cause the electronic device to execute the method disclosed above.

The computer program code for carrying out operations of the present disclosure may be written in any combination of one or more programming languages, comprising an object oriented programming language such as Java, Smalltalk, C++, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the case of remote computer, the remote computer may be connected to the user's computer through any type of network, comprising a local area network (LAN) or a wide area network (WAN), or the connection may be made to an external computer (for example, through the Internet using an Internet Service Provider).

The flowcharts and block diagrams in the figures illustrate the architecture, functionality, and operation of possible implementations of systems, methods and computer program products according to various embodiments of the present disclosure. In this regard, each block in the flowcharts or block diagrams may represent a module, program segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in a certain case.

The functions described herein above may be performed, at least in part, by one or more hardware logic components. For example, without limitation, exemplary types of hardware logic components that can be used comprise Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In the context of this disclosure, a machine readable medium may be tangible media that may contain or store a program for use by or in connection with an instruction execution system, apparatus, or device. The machine readable medium may be a machine readable signal medium or a machine readable storage medium. The machine readable medium may comprise, but is not limited to, an electronic, magnetic, optical, electromagnetic, infrared, or semiconductor system, apparatus, or device, or any suitable combination of the foregoing. More specific examples of machine readable storage media would comprise an electrical connection based on one or more wires, a portable computer diskette, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the foregoing.

According to one or more embodiments of the present disclosure, there is provided a method for processing information, comprising:
in response to a first predetermined event related to a first object, fixedly and preferentially displaying a first information item related to the first object in an information flow list of a current user;
displaying information related to the first predetermined event in the first information item, wherein the information flow list is used for displaying an information item, and the information item comprises a session item and/or a message item.

According to one or more embodiments of the present disclosure, there is provided a method for processing information, the first object is associated with a first session;
the first information item is a session item corresponding to the first session.

According to one or more embodiments of the present disclosure, there is provided a method for processing information, the first predetermined event does not comprise that a new message is generated in the first session.

According to one or more embodiments of the present disclosure, there is provided a method for processing information, the method further comprises:
in response to an operation of triggering the first information item in the information flow list, opening a session interface of the first session, wherein information of the first predetermined event is displayed at the top of the session interface of the first session.

According to one or more embodiments of the present disclosure, there is provided a method for processing information, the first session is: a session with a robot assistant;
or a group session comprising a non-robot user.

According to one or more embodiments of the present disclosure, there is provided a method for processing information,
in accordance with a determination that the session associated with the first object only comprises the session with the robot assistant, the first session is the session with the robot assistant;
or, in accordance with a determination that the session associated with the first object comprises the group session, the first session is the group session.

According to one or more embodiments of the present disclosure, there is provided a method for processing information, further comprising: after canceling the fixed and preferential display of the first information item related to the first object in the information flow list of the current user,
determining a sorting position of the first information item in the information flow list based on an update time of the first information item and displaying the first information item; the update time comprises: a time when the fixed and preferential display of the first information item is cancelled and/or a time when a new message is generated in the first session associated with the first object.

According to one or more embodiments of the present disclosure, there is provided a method for processing information,
in response to the number of the first objects is at least two, preferentially displaying, in the first information item, information related to a first predetermined event related to a target object, and aggregately displaying information related to the first predetermined event related to other first objects, wherein the target object is a first object with the earliest start time.

According to one or more embodiments of the present disclosure, there is provided a method for processing information, preferentially displaying, in the first information item, information related to the first predetermined event related to the target object, and aggregately displaying information related to the first predetermined event related to other first objects; the method further comprises: after the target object is completed, determining a next target object with the earliest start time from other uncompleted first objects, and displaying, in the first information item, information related to a first predetermined event related to the next target object with the earliest start time.

According to one or more embodiments of the present disclosure, there is provided a method for processing information, the method further comprises: in response to a predetermined operation of the first information item, switching information preferentially displayed in the first information item from information related to the first predetermined event related to the target object to information related to a first predetermined event related to another first object.

According to one or more embodiments of the present disclosure, there is provided a method for processing information, the method further comprises: in response to a trigger operation for the first information item, displaying a detail interface corresponding to the first information item, wherein the information related to a first predetermined event related to each of the first objects is displayed in the detail interface.

According to one or more embodiments of the present disclosure, there is provided a method for processing information, in accordance with a determination that at least one of the first objects is not completed, refraining from automatically cancelling the fixed and preferential display of the first information item in the information flow list of the current user, and in accordance with a determination that all the first objects are completed, automatically cancelling the fixed and preferential display of the first information item in the information flow list of the current user;
wherein in accordance with a determination that the first object is ignored, rejected, or ended, the first object is completed.

According to one or more embodiments of the present disclosure, there is provided a method for processing information, fixedly and preferentially displaying a first information item related to the first object in an information flow list of a current user comprises: fixedly displaying the first information item at the top of the information flow list of the current user.

According to one or more embodiments of the present disclosure, there is provided a method for processing information, fixedly and preferentially displaying a first information item related to the first object in an information flow list of a current user comprises:
determining a target group to which the first session belongs, the target group comprising at least one group;
fixedly and preferentially displaying the first information item in respective information flow list corresponding to each target group, or fixedly and preferentially displaying the first information item in an information flow list corresponding to a designated target group in the target group.

According to one or more embodiments of the present disclosure, there is provided a method for processing information, the method further comprises:
in response to a second predetermined event related to the first object, cancelling the fixed and preferential display of the first information item related to the first object in the information flow list of the current user.

According to one or more embodiments of the present disclosure, there is provided a method for processing information, the first object comprises a schedule;
the first predetermined event comprises: a predetermined reminder time of the schedule being up.

According to one or more embodiments of the present disclosure, there is provided a method for processing information, the method comprises at least one of the following:
the current user is a participant of the schedule, or the current user is a user among the participants of the schedule who does not reject the schedule, or the current user is a user among the participants of the schedule who accepts the schedule;
state information of the schedule is displayed in the first information item, and the state information of the schedule is updated as a state of the schedule is updated;
the method further comprises: in response to the current user's rejection of the schedule or a start time of the schedule being up, cancelling the fixed and preferential display of the first information item of the schedule.

According to one or more embodiments of the present disclosure, there is provided a method for processing information, the first object comprises a conference;

the first predetermined event comprises one or more of the following: a start of the conference, a reminder before the start of the conference.

According to one or more embodiments of the present disclosure, there is provided a method for processing information, the method comprises at least one of the following:
the current user is a participant of the conference, or the current user is a user who does not reject a schedule of the conference;
after fixedly and preferentially displaying the first information item related to the first object in the information flow list of the current user, in accordance with a determination that a conference group of the conference is created, fixedly and preferentially displaying a session item corresponding to the conference group in the information flow list, displaying information related to the first predetermined event in the session item corresponding to the conference group, and cancelling the fixed and preferential display of the first information item;
the method further comprises: in response to an operation of ignoring the conference, cancelling the fixed and preferential display of a first information item related to the conference, or in response to an end of the conference, cancelling the fixed and preferential display of the first information item related to the conference;
the method further comprises: in response to a completion operation performed on the first information item, adding the first information item to a completed group.

According to one or more embodiments of the present disclosure, there is provided a method for processing information, the method comprises at least one of the following:
the first information item has a first control for joining the conference;
the first information item has a first control for joining the conference and different types of the conference corresponding to different styles of the first control;
the first information item has a second control for ignoring the conference;
state information of the conference is displayed in the first information item, and the state information of the conference is updated as a state of the conference is updated.

According to one or more embodiments of the present disclosure, there is provided a method for processing information, in response to a first predetermined event related to a first object, highlighting a session item of a first session associated with the first object in an information flow list of a current user;
displaying information related to the first predetermined event in the session item of the first session, wherein the information flow list is used for displaying an information item, the information item comprises a session item and/or a message item, and the first predetermined event does not comprise an event of generating a new message in the first session.

According to one or more embodiments of the present disclosure, there is provided a method for processing information, the first object comprises a schedule, and the first predetermined event comprises a predetermined reminder time of the schedule being up; the first session comprises an associated group session of the schedule or a session with a schedule robot assistant;
or,
the first object comprises a conference; the first predetermined event comprises one or more of the following: a start of the conference, a reminder before the start of the conference; the first session comprises an associated group session of the conference or a session with a conference robot assistant.

According to one or more embodiments of the present disclosure, there is provided a method for processing information, the method further comprises:
in response to an operation of triggering a session item of the first session in the information flow list, opening a session interface of the first session, wherein information of the first predetermined event is displayed at the top of the session interface of the first session.

According to one or more embodiments of the present disclosure, there is provided an apparats for processing information, comprising:
a control unit configured for, in response to a first predetermined event related to a first object, fixedly and preferentially displaying a first information item related to the first object in an information flow list of a current user;
displaying information related to the first predetermined event in the first information item, wherein the information flow list is used for displaying an information item, and the information item comprises a session item and/or a message item.

According to one or more embodiments of the present disclosure, there is provided an apparatus for processing information, comprising:
a control unit configured for, in response to a first predetermined event related to a first object, highlighting a session item of a first session associated with the first object in an information flow list of a current user;
displaying information related to the first predetermined event in the session item of the first session, wherein the information flow list is used for displaying an information item, the information item comprises a session item and/or a message item, and the first predetermined event does not comprise an event of generating a new message in the first session.

According to one or more embodiments of the present disclosure, there is provided an electronic device, comprising: at least one memory and at least one processor;
wherein the at least one memory is configured for storing program code, and the at least one processor is used for invoking the program code stored in the at least one memory to execute a method of any above one.

According to one or more embodiments of the present disclosure, there is provided a computer readable storage medium configured for storing program code, wherein the program code, when run by a processor, cause the processor to execute above method.

The foregoing description is merely illustrative of the preferred embodiments of the present disclosure and of the technical principles applied thereto. As will be appreciated by those skilled in the art, the scope of the present disclosure is not limited to the technical solution formed by the specific combination of the described technical features, but should cover other technical solutions formed by any combination of the described technical features or equivalent features thereof without departing from the described disclosed concept, for example, the technical solutions that are formed by replacing the above features and technical features having similar functions disclosed in the present disclosure (but not limited thereto).

In addition, while operations are depicted in a particular order, this should not be understood as requiring that the operations be performed in the particular order shown or in sequential order. In certain circumstances, multitasking and parallel processing may be advantageous. Likewise, while several specific implementation details are comprised in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable subcombination.

Although the subject matter has been described in language specific to structural features and/or methodological acts, it should be understood that the subject matter defined in the appended claims is not necessarily limited to the specific features or acts described above. Rather, the specific features and acts described above are merely exemplary forms of implementing the claims.

What is claimed is:

1. A method for processing information, comprising:
in response to a first predetermined event related to a first object, fixedly and preferentially displaying a first information item related to the first object in an information flow list of a current user; and
displaying information related to the first predetermined event in the first information item, wherein the information flow list is used for displaying an information item, and the information item comprises a session item and/or a message item.

2. The method of claim 1, wherein,
the first object is associated with a first session;
the first information item is a session item corresponding to the first session.

3. The method of claim 2, wherein,
the first predetermined event does not comprise that a new message is generated in the first session.

4. The method of claim 2, further comprising:
in response to an operation of triggering the first information item in the information flow list, opening a session interface of the first session, wherein information of the first predetermined event is displayed at the top of the session interface of the first session.

5. The method of claim 2, wherein the first session is:
a session with a robot assistant; or
a group session comprising a non-robot user.

6. The method of claim 5, wherein,
in accordance with a determination that the session associated with the first object only comprises the session with the robot assistant, the first session is the session with the robot assistant; or,
in accordance with a determination that the session associated with the first object comprises the group session, the first session is the group session.

7. The method of claim 1, further comprising:
after canceling the fixed and preferential display of the first information item related to the first object in the information flow list of the current user, determining a sorting position of the first information item in the information flow list based on an update time of the first information item and displaying the first information item; the update time comprises: a time when the fixed and preferential display of the first information item is cancelled and/or a time when a new message is generated in the first session associated with the first object.

8. The method of claim 1, wherein,
in response to the number of the first objects is at least two, preferentially displaying, in the first information item, information related to a first predetermined event related to a target object, and aggregately displaying information related to the first predetermined event related to other first objects, wherein the target object is a first object with the earliest start time.

9. The method of claim 8, wherein the method comprises at least one of the following:
preferentially displaying, in the first information item, information related to the first predetermined event related to the target object, and aggregately displaying information related to the first predetermined event related to other first objects; the method further comprises: after the target object is completed, determining a next target object with the earliest start time from other uncompleted first objects, and displaying, in the first information item, information related to a first predetermined event related to the next target object with the earliest start time;
the method further comprises: in response to a predetermined operation of the first information item, switching information preferentially displayed in the first information item from information related to the first predetermined event related to the target object to information related to a first predetermined event related to another first object;
the method further comprises: in response to a trigger operation for the first information item, displaying a detail interface corresponding to the first information item, wherein the information related to a first predetermined event related to each of the first objects is displayed in the detail interface;
in accordance with a determination that at least one of the first objects is not completed, refraining from automatically cancelling the fixed and preferential display of the first information item in the information flow list of the current user, and in accordance with a determination that all the first objects are completed, automatically cancelling the fixed and preferential display of the first information item in the information flow list of the current user;
wherein in accordance with a determination that the first object is ignored, rejected, or ended, the first object is completed.

10. The method of claim 1, wherein fixedly and preferentially displaying a first information item related to the first object in an information flow list of a current user comprises: fixedly displaying the first information item at the top of the information flow list of the current user.

11. The method of claim 2, wherein fixedly and preferentially displaying a first information item related to the first object in an information flow list of a current user comprises:
determining a target group to which the first session belongs, the target group comprising at least one group;
fixedly and preferentially displaying the first information item in respective information flow list corresponding to each target group, or fixedly and preferentially displaying the first information item in an information flow list corresponding to a designated target group in the target group.

12. The method of claim 1, further comprising:
in response to a second predetermined event related to the first object, cancelling the fixed and preferential display of the first information item related to the first object in the information flow list of the current user.

13. The method of claim 1, wherein,
the first object comprises a schedule;
the first predetermined event comprises: a predetermined reminder time of the schedule being up.

14. The method of claim 13, wherein the method comprises at least one of the following:
the current user is a participant of the schedule, or the current user is a user among the participants of the schedule who does not reject the schedule, or the current user is a user among the participants of the schedule who accepts the schedule;
state information of the schedule is displayed in the first information item, and the state information of the schedule is updated as a state of the schedule is updated;
the method further comprises: in response to the current user's rejection of the schedule or a start time of the schedule being up, cancelling the fixed and preferential display of the first information item of the schedule.

15. The method of claim 1, wherein,
the first object comprises a conference;
the first predetermined event comprises one or more of the following: a start of the conference, a reminder before the start of the conference.

16. The method of claim 15, wherein the method comprises at least one of the following:
the current user is a participant of the conference, or the current user is a user who does not reject a schedule of the conference;
after fixedly and preferentially displaying the first information item related to the first object in the information flow list of the current user, in accordance with a determination that a conference group of the conference is created, fixedly and preferentially displaying a session item corresponding to the conference group in the information flow list, displaying information related to the first predetermined event in the session item corresponding to the conference group, and cancelling the fixed and preferential display of the first information item;
the method further comprises: in response to an operation of ignoring the conference, cancelling the fixed and preferential display of a first information item related to the conference, or in response to an end of the conference, cancelling the fixed and preferential display of the first information item related to the conference;
the method further comprises: in response to a completion operation performed on the first information item, adding the first information item to a completed group.

17. The method of claim 15, wherein the method comprises at least one of the following:
the first information item has a first control for joining the conference;
the first information item has a first control for joining the conference and different types of the conference corresponding to different styles of the first control;
the first information item has a second control for ignoring the conference;
state information of the conference is displayed in the first information item, and the state information of the conference is updated as a state of the conference is updated.

18. An electronic device, comprising:
at least one memory and at least one processor;
wherein the at least one memory is configured for storing program code, and the at least one processor is used for invoking the program code stored in the at least one memory to perform acts comprising:
in response to a first predetermined event related to a first object, fixedly and preferentially displaying a first information item related to the first object in an information flow list of a current user; and
displaying information related to the first predetermined event in the first information item, wherein the information flow list is used for displaying an information item, and the information item comprises a session item and/or a message item.

19. The electronic device of claim 18, wherein the acts further comprise:
after canceling the fixed and preferential display of the first information item related to the first object in the information flow list of the current user, determining a sorting position of the first information item in the information flow list based on an update time of the first information item and displaying the first information item; the update time comprises: a time when the fixed and preferential display of the first information item is cancelled and/or a time when a new message is generated in the first session associated with the first object.

20. A non-transitory computer readable storage medium configured for storing program code, wherein the program code, when run by a processor, cause the processor to perform acts comprising:
in response to a first predetermined event related to a first object, fixedly and preferentially displaying a first information item related to the first object in an information flow list of a current user; and
displaying information related to the first predetermined event in the first information item, wherein the information flow list is used for displaying an information item, and the information item comprises a session item and/or a message item.
